(19) United States
(12) Patent Application Publication
(10) Pub. No.: US 2019/0246283 A1
(43) Pub. Date: Aug. 8, 2019

(54) METHOD FOR PREVENTING NETWORK LOCKING INFORMATION OF TERMINAL DEVICE FROM BEING CRACKED

(71) Applicant: Shenzhen Jia Ren Xun Information Technology Co., Ltd., Shenzhen (CN)

(72) Inventor: Zhuo Wu, shenzhen (CN)

(21) Appl. No.: 15/542,539

(22) PCT Filed: Oct. 25, 2016
(86) PCT No.: PCT/CN2016/103136

§ 371 Date: Jul. 10, 2017

(51) Int. Cl. H04W 12/12

(52) U.S. Cl. CPC H04W 12/12

(57) ABSTRACT

The present disclosure provides a method for preventing network locking information of a terminal device from being cracked. The method aims at the technical defects in the art, specifically, the network locking information of conventional terminal devices sold by the operator is easily cracked, so that the terminal devices can be used in the network of other operators, causing the profit loss of the mobile operators, the method in the present disclosure can, after detecting the network locking information of the terminal devices has been tampered with, issue the default network locking information of the terminal devices via a server to restore the network locking information of the terminal device. This ensures the network locking information of the terminal devices cannot be tampered with and the terminal devices can always reside on the preset network of the operators, thus guaranteeing the interests of the operators.

### FIELD OF THE INVENTION

The invention relates to the field of preventing the network locking information of terminal devices from being cracked, and repairing and restoring the default network locking information of terminal devices, and more particularly, to a method for preventing the network locking information of terminal devices from being cracked.

### BACKGROUND OF THE INVENTION

At present, it is a common marketing strategy for the operators all over the world to sell in a low price or provide the terminal devices to users for free so as to bind the users to their mobile network. To ensure the sold terminal devices can only reside on their own network, the operators often lock the software versions of the terminal devices to the network, so that the terminal devices cannot work until a SIM card approved by the operators is inserted.

Because the terminal devices obtained from the aforesaid channel are cheap, some people attempt to tamper with the software versions of the terminal devices to crack the network locking information, so that SIMs of other operators are applicable to the terminal devices. This invalidates the marketing strategy of the operators, and the operators cannot get back the subsidy and gain the profits for each mobile phone subsequently, suffering from huge loss.

### SUMMARY OF THE INVENTION

In view of the above-described problems, it is one objective of the invention to provide a method for preventing network locking information of a terminal device from being cracked.

To achieve the above objective, the following technical solutions are adopted.

The method comprises the following steps:
S1: monitoring a network status of a terminal device upon being powered on, and determining whether the terminal device resides on a mobile network;
S2: if it is monitored that the terminal device resides on a mobile network, acquiring network locking relevant information of the terminal device, if not, continuing monitoring;
S3: comparing the acquired network locking relevant information with network locking information stored in the terminal device, if the network locking information changes, reporting relevant information of the terminal device to a server, conversely, if the network locking information is unchanged, shifting to S 8; for terminal devices being powered on for the first time, because no network locking information is previously stored, the relevant information of the terminal devices must be reported to a server;
S4: acquiring, by the server, request data information transmitted from the terminal device, and looking up, by the server, whether there exists corresponding network locking information data package according to the relevant information of the terminal device, and transmitting relevant information to the terminal device;
S5: receiving, by the terminal device, the relevant information sent back from the server, examining, by the terminal device, whether there is network locking data package information, if yes, encrypting and storing the network locking information, and downloading the network locking data package, conversely, if the server does not issue the network locking data package information, encrypting and storing current network locking information, and shifting to S8;
S6: after downloading the network locking data package, updating, by the terminal device, the network locking information, using the downloaded network locking data package;
S7: reporting, by the terminal device, upgradation result to the server after the upgrading is finished; and
S8: the flow ends.

Further, in S2, the network locking relevant information of the terminal device is identification codes of mobile subscribers; in S3, the relevant information of the terminal device comprises device type, version number, device ID, and network locking information.

Specifically, in S3, reporting the relevant information of the terminal device to the server comprises:
S3.1) sending, by the terminal device, a request for transmitting data to the server;
S3.2) determining whether a network data link of the terminal device is established;
S3.3) if not, monitoring, by the terminal device, a status of the network data link, and shifting to S3.4), if yes, transmitting data to the server, and shifting to S3.5);
S3.4) if the network data link of the terminal device is established, transmitting data to the server, if not, continue monitoring;
S3.5) determining whether the data is transmitted successfully, if yes, shifting to S3.6), if not, retry count is incremented by 1, and determining whether the retry count is greater than a threshold value, if yes, shifting to S3.6), if not, retrying to transmit data; and
S3.6) the flow ends.

Advantages of the method of the present disclosure are summarized as follows.

The present disclosure provides a method for preventing network locking information of a terminal device from being cracked. Compared with the technologies in the art, specifically, the network locking information of conventional terminal devices sold by the operator is easily cracked, so that the terminal devices can be used in networks of other operators, causing the profit loss of the mobile operators, the method for preventing the network locking information of terminal devices from being cracked in the present disclosure can, after detecting the network locking information of the terminal devices has been tampered with, issue the default network locking information of the terminal devices via the server to restore the network locking information of the terminal device. This ensures the network locking information of the terminal devices cannot be tampered with and the terminal devices can always reside on the preset network of the operators, thus guaranteeing the interests of the operators.

### BRIEF DESCRIPTION OF THE DRAWINGS

FIG. 1 is a flow chart of a method for preventing the network locking information of terminal devices from being cracked according to an embodiment of the present invention; and

FIG. 2 is a flow chart of data transmission from a terminal device to a server according to an embodiment of the present invention.

### DETAILED DESCRIPTION OF THE EMBODIMENTS

To further illustrate the invention, embodiments detailing a method for preventing the network locking information of terminal devices from being cracked are described below.

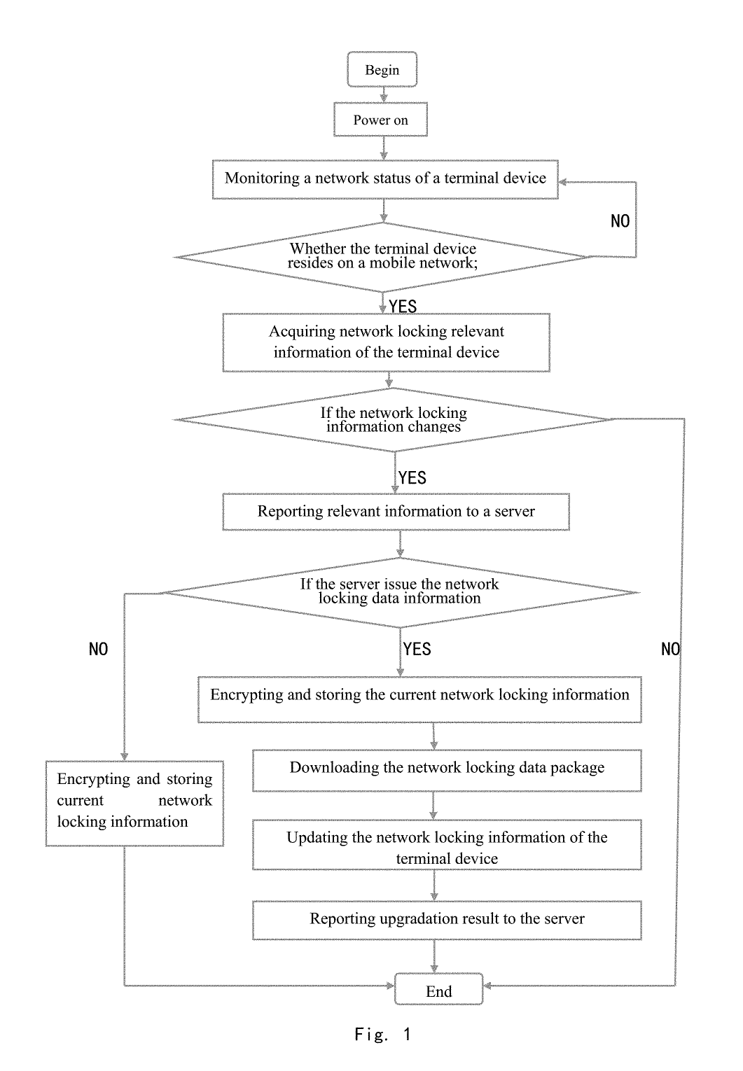

As shown in FIG. 1, a method for preventing the network locking information of terminal devices from being cracked comprises the following steps:
S1: monitoring a network status of a terminal device upon being powered on, and determining whether the terminal device resides on a mobile network;
S2: if it is monitored that the terminal device resides on a mobile network, acquiring network locking relevant information of the terminal device, if not, continuing monitoring;
S3: comparing the acquired network locking relevant information with network locking information stored in the terminal device, if the network locking information changes, reporting relevant information of the terminal device to a server, conversely, if the network locking information is unchanged, shifting to S 8; for terminal devices being powered on for the first time, because no network locking information is previously stored, the relevant information of the terminal devices must be reported to a server;
S4: acquiring, by the server, request data information transmitted from the terminal device, and looking up, by the server, whether there exists corresponding network locking information data package according to the relevant information of the terminal device, and transmitting relevant information to the terminal device;
S5: receiving, by the terminal device, the relevant information sent back from the server, examining, by the terminal device, whether there is network locking data package information, if yes, encrypting and storing the network locking information, and downloading the network locking data package, conversely, if the server does not issue the network locking data package information, encrypting and storing current network locking information, and shifting to S8;
S6: after downloading the network locking data package, updating, by the terminal device, the network locking information, using the downloaded network locking data package;
S7: reporting, by the terminal device, upgradation result to the server after the upgrading is finished; and
S8: the flow ends.

Further, in S2, the network locking relevant information of the terminal device is identification codes of mobile subscribers; in S3, the relevant information of the terminal device comprises device type, version number, device ID, and network locking information.

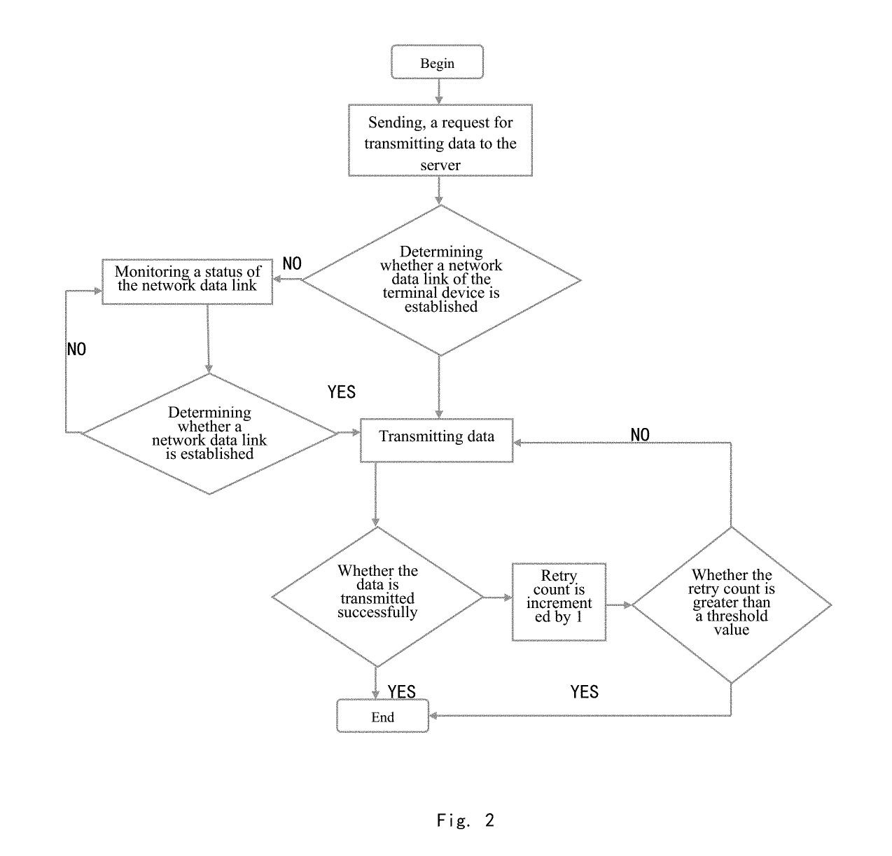

As shown in FIG. 2, in S3, reporting the relevant information of the terminal device to the server comprises:
S3.1) sending, by the terminal device, a request for transmitting data to the server;
S3.2) determining whether a network data link of the terminal device is established;
S3.3) if not, monitoring, by the terminal device, a status of the network data link, and shifting to S3.4), if yes, transmitting data to the server, and shifting to S3.5);
S3.4) if the network data link of the terminal device is established, transmitting data to the server, if not, continue monitoring;
S3.5) determining whether the data is transmitted successfully, if yes, shifting to S3.6), if not, retry count is incremented by 1, and determining whether the retry count is greater than a threshold value, if yes, shifting to S3.6), if not, retrying to transmit data; and
S3.6) the flow ends.

In the present disclosure, after the terminal device is powered on, the mobile network information thereof is detected. When the mobile network information is changed, the terminal device transmits the current relevant information thereof to the server, the server detects the relevant information of the terminal device, when it is determined that the network locking information of the terminal device has been cracked, the server issues the default network locking information, the terminal device receives the default network locking information to restore the network information thereof, so that the terminal device can only reside on the preset network of the operator.

Compared with the prior art, the present invention provides a method to dynamically monitor the network locking information of the terminal devices, if it is changed, the server issues preset network locking information to restore the preset information of the terminal device. Conventionally, the network locking information is protected by using encryption, however, once the encrypted information is cracked, the network locking information may be tampered with and cannot be restored. Furthermore, a hardware lock is disposed on the terminal hardware, to prevent the network locking information of the terminal device from being tampered with, but the method cannot avoid the alteration of the network locking information of the terminal device by upgrading the SD card. That is, current operators and terminal manufactures have no effective means in preventing the network locking information of the terminal device from being tampered with. The method of the present disclosure can effectively and dynamically monitor and restore the network locking information of the terminal device, thus protecting the interests of the operators.

In summary, the method for preventing the network locking information of terminal devices from being cracked solves the long-standing problem that the network locking information of the current customized terminal devices sold by operators cannot be effectively protected from being cracked, thus causing the loss of the clients and the subsidy for the terminal devices, so the method can effectively protect the interests of the operators.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A method for preventing network locking information of a terminal device from being cracked, the method comprising:
S1: monitoring a network status of a terminal device upon being powered on, and determining whether the terminal device resides on a mobile network;
S2: if it is monitored that the terminal device resides on a mobile network, acquiring network locking relevant information of the terminal device, if not, continuing monitoring;
S3: comparing the acquired network locking relevant information with network locking information stored in the terminal device, if the network locking information changes, reporting relevant information of the terminal device to a server, conversely, if the network locking information is unchanged, shifting to S 8; for terminal devices being powered on for the first time, because no network locking information is previously stored, the relevant information of the terminal devices must be reported to a server;
S4: acquiring, by the server, request data information transmitted from the terminal device, and looking up, by the server, whether there exists corresponding network locking information data package according to the relevant information of the terminal device, and transmitting relevant information to the terminal device;
S5: receiving, by the terminal device, the relevant information sent back from the server, examining, by the terminal device, whether there is network locking data package information, if yes, encrypting and storing the network locking information, and downloading the network locking data package, conversely, if the server does not issue the network locking data package information, encrypting and storing current network locking information, and shifting to S8;
S6: after downloading the network locking data package, updating, by the terminal device, the network locking information, using the downloaded network locking data package;
S7: reporting, by the terminal device, upgradation result to the server after the upgrading is finished; and
S8: the flow ends.

2. The method of claim 1, wherein in S2, the network locking relevant information of the terminal device is identification codes of mobile subscribers.

3. The method of claim 1, wherein in S3, the relevant information of the terminal device comprises device type, version number, device ID, and network locking information.

4. The method of claim 1, wherein in S3, reporting the relevant information of the terminal device to the server comprises:
S3.1) sending, by the terminal device, a request for transmitting data to the server;
S3.2) determining whether a network data link of the terminal device is established;
S3.3) if not, monitoring, by the terminal device, a status of the network data link, and shifting to S3.4), if yes, transmitting data to the server, and shifting to S3.5);
S3.4) if the network data link of the terminal device is established, transmitting data to the server, if not, continue monitoring;
S3.5) determining whether the data is transmitted successfully, if yes, shifting to S3.6), if not, retry count is incremented by 1, and determining whether the retry count is greater than a threshold value, if yes, shifting to S3.6), if not, retrying to transmit data; and
S3.6) the flow ends.
